(19) United States
(12) Patent Application Publication
(10) Pub. No.: US 2015/0235501 A1
(43) Pub. Date: Aug. 20, 2015

(54) Prize-Dispensing Apparatus

(71) Applicant: YOUAL JIFH ENTERPRISE CO., LTD., Taichung City (TW)

(72) Inventor: Chih-Chieh Wang, TAICHUNG CITY (TW)

(73) Assignee: YOUAL JIFH ENTERPRISE CO., LTD., Taichung City (TW)

(21) Appl. No.: 14/184,701

(22) Filed: Feb. 19, 2014

(51) Int. Cl. G07F 11/36; G07F 11/42

(52) U.S. Cl. CPC G07F 11/36; G07F 11/42

(57) ABSTRACT

A conveyor-and-hanger combination includes a helical conveyor and hangers. The helical conveyor unit includes a bracket, an axle, a shaft, a helical conveyor and a rod. The axle is rotationally connected to the bracket. The shaft is connected to the axle so that they are rotatable with each other. The helical conveyor is connected to the axle so that they are rotatable with each other. The helical conveyor extends around the shaft and includes a slit between any two adjacent turns. The rod is non-movably connected to the bracket below the helical conveyor. Each hanger includes a platform and a hook. The platform supports a prize. The hook extends from the platform and includes a tip separated from the platform by a gap. The hook enters a corresponding slit while hooking the rod. The rod is transversely moved through the gap while the hook is moved onto the rod.

### BACKGROUND OF INVENTION

1. Field of the Invention

The present invention relates to a game machine and, more particularly, to a prize-dispensing apparatus for a game machine.

2. Related Prior Art

There are various game machines. Each game machine includes a prize-dispensing apparatus. The prize-dispensing apparatus may include a clamp, a pair of scissors, or conveyor-and-hanger combinations for example.

As disclosed in Taiwanese Patent Application No. 092216185 for example, a conveyor-and-hanger combination 200 includes a helical conveyor 230, a rod 240 and a beam 250. Each prize 10 is tied to a loop 11. Each loop 11 is placed in a gap between two corresponding adjacent turns of the helical conveyor 230 when it is hung on the rod 240. The beam 250 is inserted in the loops 11. The helical conveyor 230 is rotated to convey the prizes 10 along the rod 240 while the beam 250 prevents the loops 11 from rotation. Thus, one after another, the prizes 10 are released from the rod 240. However, it is troublesome to hang the prizes 10 on the conveyor-and-hanger combination 200 because each loop 11 must be moved along the conveyor-and-hanger combination 200 and could easily get tangled with the helical conveyor 230 before it reaches its intended position.

As disclosed in Taiwanese Patent Application No. 101203129 for example, a conveyor-and-hanger includes a helical conveyor 24 and a beam 11. Each prize 100 is tied to a loop (not numbered). Each loop is placed in a gap between two corresponding adjacent turns of the helical conveyor 24 when it is hung on the beam 11. The helical conveyor 24 is rotated to convey the prizes 100 along the beam 11. Thus, one after another, the prizes 100 are released from the beam 11. However, it is troublesome to hang the prizes 100 on the conveyor-and-hanger combination because each loop must be moved along the conveyor-and-hanger combination and could easily get tangled with the helical conveyor 24 before it reaches its intended position.

The present invention is therefore intended to obviate or at least alleviate the problems encountered in prior art.

### SUMMARY OF INVENTION

It is the primary objective of the present invention to provide a game machine with a prize-dispensing apparatus that allows convenient refill.

To achieve the foregoing objective, the conveyor-and-hanger combination includes a helical conveyor and hangers. The helical conveyor unit includes a bracket, an axle, a shaft, a helical conveyor and a rod. The axle is rotationally connected to the bracket. The shaft is connected to the axle so that they are rotatable with each other. The helical conveyor is connected to the axle so that they are rotatable with each other. The helical conveyor extends around the shaft and includes a slit between any two adjacent turns. The rod is non-movably connected to the bracket below the helical conveyor. Each hanger includes a platform and a hook. The platform supports a prize. The hook extends from the platform and includes a tip separated from the platform by a gap. The hook enters a corresponding slit while hooking the rod. The rod is transversely moved through the gap while the hook is moved onto the rod.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a perspective view of a helical conveyor unit according to the preferred embodiment of the present invention;

FIG. 2 is a cross-sectional view of the helical conveyor unit illustrated in FIG. 1;

FIG. 3 is a perspective view of prizes hung on the helical conveyor unit shown in FIG. 1;

FIG. 4 is a perspective view of a prize-dispensing apparatus including a plurality of helical conveyor units as shown in FIG. 1; and

FIG. 5 is a perspective view of a driver unit engaged with the helical conveyor unit shown in FIG. 1.

### DETAILED DESCRIPTION OF PREFERRED EMBODIMENT

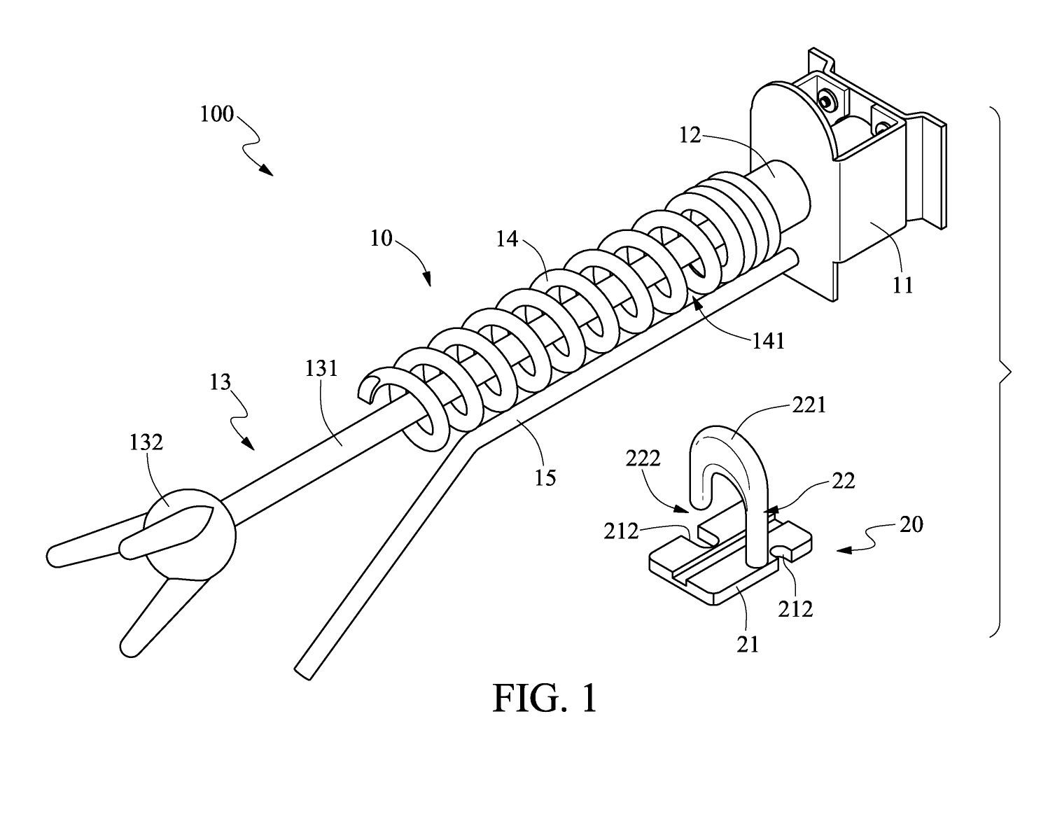

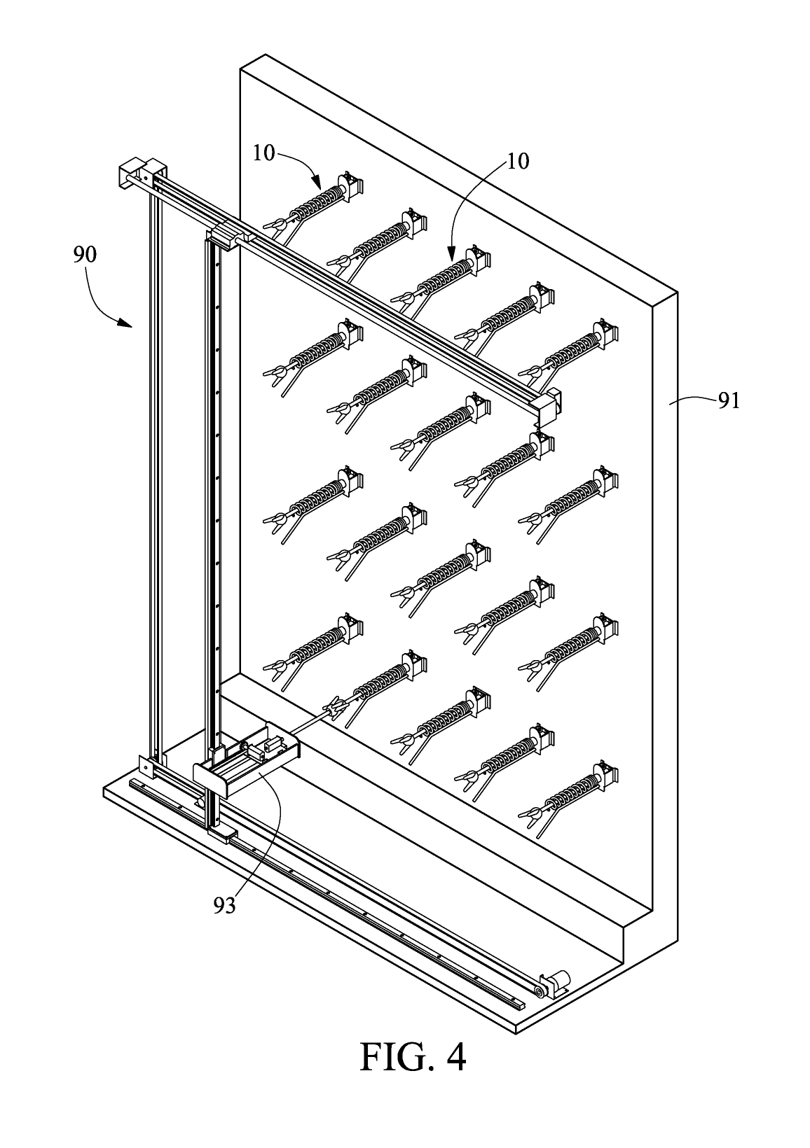

Referring to FIGS. 1 and 4, a prize-dispensing apparatus 90 includes a plate 91, a driver unit 93 and many conveyor-and-hanger combinations 100 according to the preferred embodiment of the present invention. The plate 91 is used to support the conveyor-and-hanger combinations 100. The driver unit 93 is movable and operable to drive the conveyor-and-hanger combinations 100, one at a time.

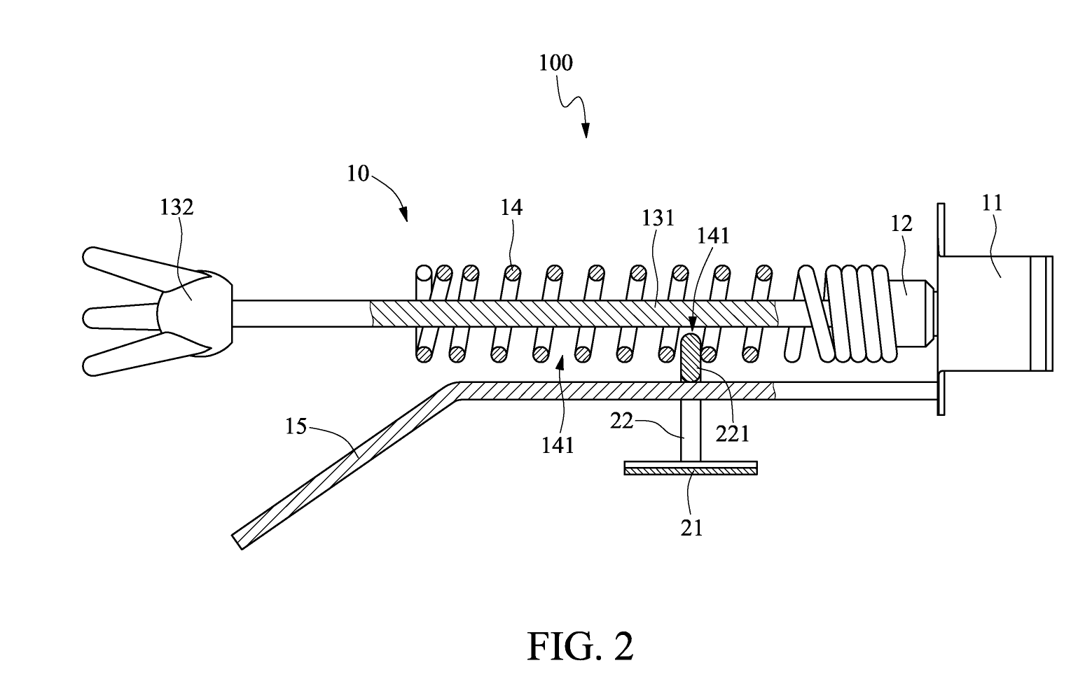

Referring to FIGS. 1 and 2, each of the conveyor-and-hanger combinations 100 includes a helical conveyor unit 10 and three hangers 20 for example. The helical conveyor unit 10 includes a bracket 11, an axle 12, a shaft 13, a helical conveyor 14 and a rod 15. The bracket 11 is non-movably connected to the plate 91. The axle 12 is rotationally supported on the bracket 11.

The shaft 13 includes a shank 131 and a claw 132. An end of the shank 131 is secured to the axle 12 so that the shank 131 is rotatable with the axle 12. Another end of the shank 131 is secured to the claw 132 so that the shank 131 is rotatable with the claw 132.

The helical conveyor 14 is made of a wire that helically extends around the shaft 13. The pitch of the helical conveyor 14 is larger than the diameter of the wire so that there is a slit 141 between any two adjacent turns of the helical conveyor 14. The helical conveyor 14 is preferably a helical spring. An end of the helical conveyor 14 is connected to the axle 12 so that the helical conveyor 14 is rotatable with the axle 12.

The rod 15 includes a horizontal section non-movably connected to the bracket 11 and a slant section extending from the horizontal section. The rod 15 is located below the helical conveyor 14.

Each of the hangers 20 includes a platform 21 and a hook 22. The platform 21 includes two cutouts 212 made in two opposite edges. The hook 22 includes a foot (not numbered) connected to the platform 21 and a tip 221 separated from the platform 21 by a gap 222.

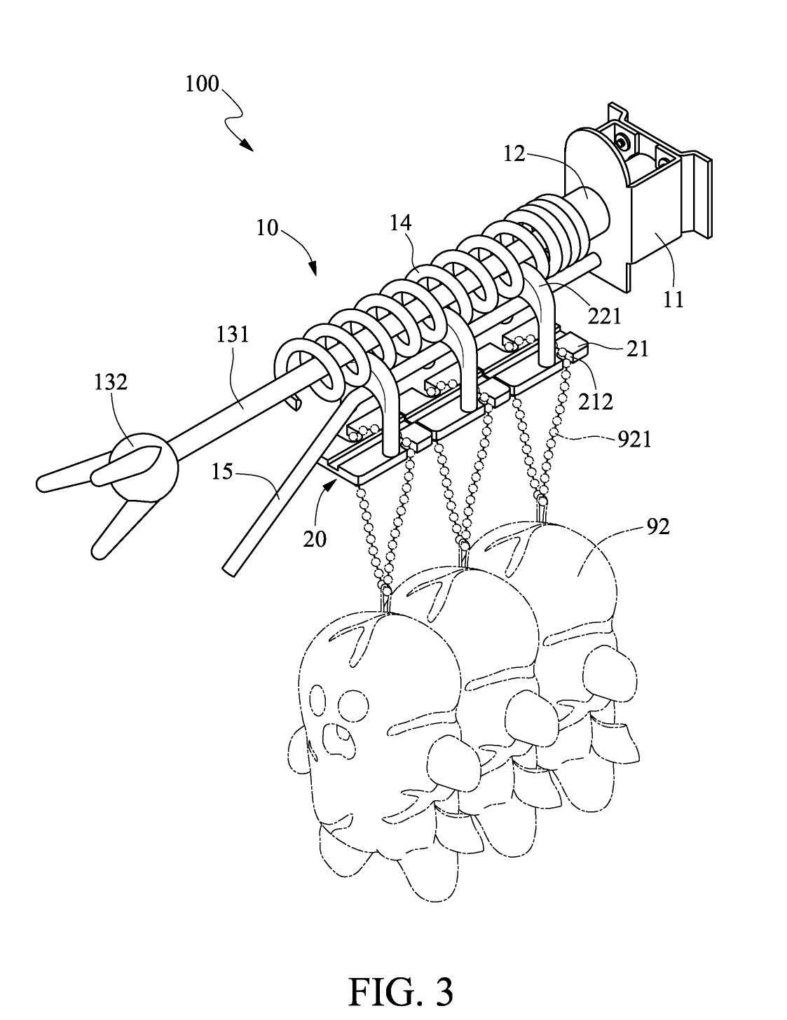

Referring to FIG. 3, each of the conveyor-and-hanger combinations 100 is used to support three prizes 92 for example. Each of the prizes 92 is tied to a loop 921. The loop 921 for each prize 92 is supported on the platform 21 of a corresponding hanger 20, with two portions of the loop 921 placed in the cutouts 212 of the platform 21 so that the prize 92 is firmly supported on the platform 21. The hooks 22 of the hangers 20 are supported on the horizontal section of the rod 15. The hook 22 of each hanger 20 is inserted in the slit 141 between two corresponding adjacent turns of the helical conveyor 14. Thus, the prizes 92 hung on the rod 15 by the hangers 20 are movable along the horizontal section of the rod 15 when the helical conveyor 14 is rotated. A phantom line (not shown) that interconnects the cutout 212 does not extend perpendicular to a path of movement of the platform 21.

Referring to FIG. 4, the driver unit 93 is moved and aligned with a selected one of the conveyor-and-hanger combinations 100.

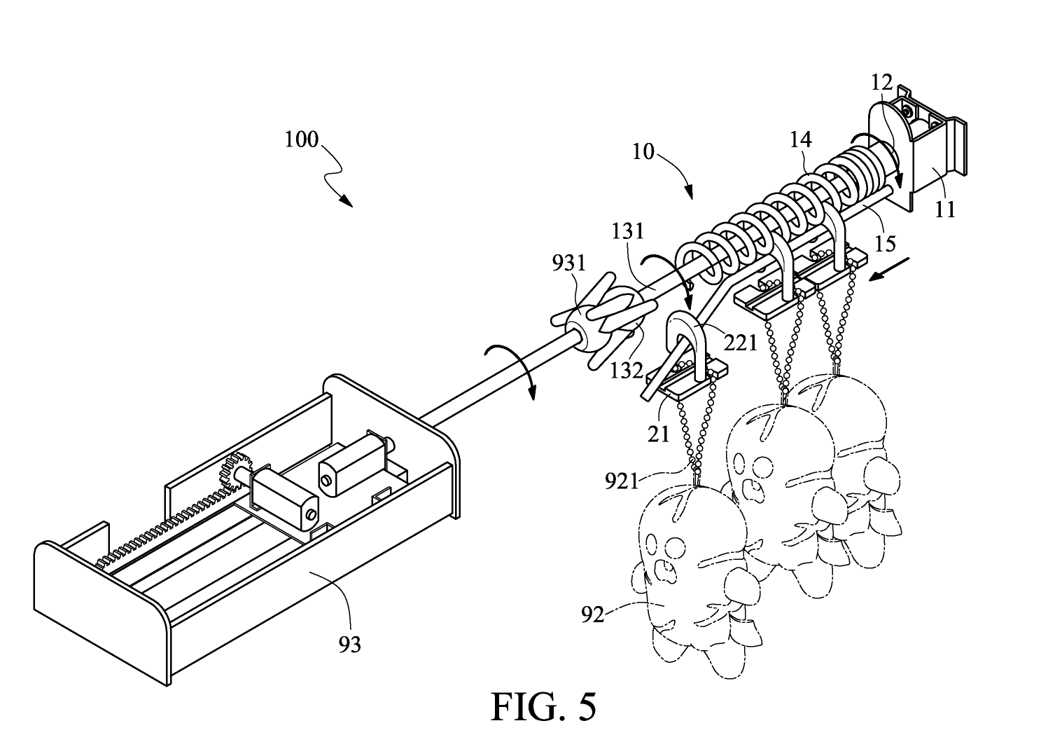

Referring to FIG. 5, the driver unit 93 includes a claw 931 formed at an end of a shank (not numbered). The shank of the driver unit 93 is movable toward the selected conveyor-and-hanger combination 100 to engage the claw 931 with the claw 132 of the selected conveyor-and-hanger combination 100. The driver unit 93 is actuated to the rotate the helical conveyor 14 of the selected conveyor-and-hanger combination 100 to move the prizes 92 hung on the rod 15 by the hangers 20 along the rod 15. Thus, a leading one of the prizes 92 is moved onto the slant section of the rod 15 from the horizontal section. The leading prize 92 falls from the slant section of the rod 15 because of gravity.

To refill the prize-dispensing apparatus 90, i.e., hang new prizes 92 on the convey-and-hanger units 100, the process discussed above referring to FIG. 3 is repeated.

Advantageously, the gap 222 between the hook 22 of each hanger 20 and the platform 21 enables easy hanging of the hanger 20 onto the rod 15. This is because it is not necessary to actuate the driver unit 93 to rotate the helical conveyors 14 to move the hooks 22 the hangers 20 along the rods 15.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A conveyor-and-hanger combination including:
a helical conveyor unit 10 including:
a bracket 11;
an axle 12 rotationally connected to the bracket 11
a shaft 13 connected to the axle 12 so that they are rotatable with each other;
a helical conveyor 14 connected to the axle 12 so that they are rotatable with each other, wherein the helical conveyor 14 extends around the shaft 13, wherein the helical conveyor 14 includes a slit 141 between any two adjacent turns; and
a rod 15 non-movably connected to the bracket 11 below the helical conveyor 14; and
hangers 20 each including:
a platform 21 for supporting a prize 92; and
a hook 22 extending from the platform 21 and including a tip 221 separated from the platform 21 by a gap 222, wherein the hook 22 enters a corresponding slit 141 while hooking the rod 15, wherein the rod 15 is transversely moved through the gap 222 while the hook 22 is moved onto the rod 15.

2. The conveyor-and-hanger combination according to claim 1, wherein the shaft 13 includes a shank 131 connected to the axle 12 and a claw 132 formed on the shank 131, wherein the claw 132 can be engaged with a claw 931 of a driver unit 93.

3. The conveyor-and-hanger combination according to claim 1, wherein the helical conveyor 14 is a helical spring.

4. The conveyor-and-hanger combination according to claim 1, wherein the platform 21 includes two cutouts 212 for receiving portions of a loop 921 tied to a prize 92.

5. The conveyor-and-hanger combination according to claim 4, wherein the cutouts 212 are located at two ends of a phantom line that does not extend perpendicular to a path of movement of the platform 21.
